(19) United States
(12) Patent Application Publication
(10) Pub. No.: US 2026/0300141 A1
(43) Pub. Date: Oct. 1, 2026

(54) DYNAMIC CODE GENERATION OF TRACEPOINTS AND ENVIRONMENT-SPECIFIC CODE COVERAGE CALCULATION

(71) Applicant: Cisco Technology, Inc., San Jose, CA (US)

(72) Inventor: Stephen Craig Connors, JR., Nashville, TN (US)

(21) Appl. No.: 19/199,637

(22) Filed: May 6, 2025

Related U.S. Application Data
(60) Provisional application No. 63/780,839, filed on Mar. 31, 2025.

(51) Int. Cl. G06F 11/3668; G06F 11/362

(52) U.S. Cl. CPC G06F 11/3676; G06F 11/3636

(57) ABSTRACT

A system and method are provided for dynamically determining an environment-specific code coverage. Tracepoints are embedded in a first version of source code sing a macro that generates the unique identifier of a tracepoint based on one or more compile-time parameters associated with the tracepoint (e.g., the file and line of the tracepoint). A historical log of all tracepoints executed for the source code (including for previous versions) is generated by registering each executed tracepoint in persistent memory, upon its execution. The number of tracepoints executed at least once during a runtime session is counted, and the dynamic code coverage can be calculated using a ratio of the runtime count divided by the number of tracepoints in the historical log.

### BACKGROUND

Software testing is used to ensure that the software is reliable and secure prior to deployment. Software testing can detect and remediate bugs, vulnerabilities, and unexpected behaviors before the software is deployed. By verifying functionality and simulating different conditions, testing helps minimize issues that could disrupt users, cause downtime, or require rollback of deployments.

Testing is also integrated with modern deployment strategies such as rolling upgrades, blue/green deployments, and CI/CD pipelines. These methods reduce deployment risk and rely on automated testing to validate changes before and after release. Effective testing supports system stability and enables faster, more confident software updates.

To evaluate how thoroughly software has been exercised, teams can use code coverage analysis. Tools like GCOV and LCOV support this by instrumenting compiled code and generating coverage reports, helping teams assess test completeness. In addition, dynamic instrumentation frameworks such as DTrace and SystemTap can be used for real-time monitoring of software without modifying the source code.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a block diagram of an example of a computing device in accordance with some embodiments of the present technology.

FIG. 2 illustrates a flow diagram of a method for dynamically calculating environment-specific code coverage in accordance with some embodiments of the present technology.

FIG. 3A illustrates a block diagram of a first example of a network, in accordance with some embodiments of the present technology.

FIG. 3B illustrates a block diagram of a second example of the network, in accordance with some embodiments of the present technology.

FIG. 4 illustrates a block diagram of a network device, in accordance with some embodiments of the present technology.

FIG. 5 illustrates a flow diagram for an example of a method of implementing a software development lifecycle (SDLC), in accordance with some embodiments of the present technology.

FIG. 6 illustrates a state diagram for an example of a step for deploying a new software/policy version using dual dataplanes, in accordance with some embodiments of the present technology.

FIG. 7 illustrates a block diagram of a first example of implementing dual dataplanes in data processing units (DPUs), in accordance with some embodiments of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method for dynamically determining an environment-specific code coverage, the method including: embedding tracepoints in a first version of source code, each of the tracepoints having a unique identifier; determining first information representing first set of the tracepoints that have been executed at least once within a first period; determining second information representing second set of the tracepoints that have been activated during a second period spanning a first test of the first version of the source code; and analyzing the first information and the second information to generate an analysis result representing a code coverage of the first test.

In some aspects, the techniques described herein relate to a method, wherein: the tracepoints are embedded in the first version of the source code using a macro that generates the unique identifier of a tracepoint based on one or more compile-time parameters associated with the tracepoint, the determining of the first information includes registering the first set of the tracepoints when first executed, the first set of the tracepoints being registered by storing unique identifiers of the first set of the tracepoints in a persistent memory, and the first information includes a first count representing how many tracepoints are in the first set of the tracepoints, and the determining of the second information includes counting the second set of the tracepoints, which are activated during a runtime session of the first test, to provide a second count representing how many tracepoints are in the second set of the tracepoints.

In some aspects, the techniques described herein relate to a method, wherein the one or more compile-time parameters associated with the tracepoint include at least one of a file name or a line number.

In some aspects, the techniques described herein relate to a method, wherein the analysis result includes a ratio of the second count and the first count.

In some aspects, the techniques described herein relate to a method, wherein the unique identifier is generated using at least one of a file name or a line number of the tracepoint.

In some aspects, the techniques described herein relate to a method, wherein: the first period includes a testing period that includes a first time during which the first version of the source code is executed and includes a historical period during which a second version of the source code is executed, the second period includes the testing period that includes a second time during which the first version of the source code is executed, the first version of the source code is a next version of the source code, and the second version of the source code is a current version of the source code or a previous version of the source code, and a list of the unique identifiers of the tracepoints that is stored in a persistent memory is a historical log of tracepoints that have been active in a specific environment.

In some aspects, the techniques described herein relate to a method, further including: replacing, in a production environment, a previous program based on the second version of the source code with an updated program based on the first version of the source code, when the analysis result satisfies one or more code-coverage criteria.

In some aspects, the techniques described herein relate to a method, wherein the determining of the first information includes: generating a historical log of tracepoints that have been active in an environment as the first set of the tracepoints, and the historical log is generated by storing, upon a first execution of a tracepoint, the unique identifier of the tracepoint in a persistent storage medium.

In some aspects, the techniques described herein relate to a method, wherein the determining of the first information includes: ensuring each of the tracepoints is registered at most once by defining a registers-tracepoint function that registers a tracepoint only upon a first time the tracepoint is executed, wherein the registers-tracepoint function is defined using a static flag and a mutual exclusion synchronization primitive that provides thread safety.

In some aspects, the techniques described herein relate to a method, wherein determining the first information representing the first set of the tracepoints is dynamic such that the first set of the tracepoints dynamically grows to provide an environment-specific code coverage such that the first period begins at a start time but is open ended with respect an end time, wherein newly executed tracepoints continue to be added to the first set of the tracepoints.

In some aspects, the techniques described herein relate to a method, wherein storing the unique identifier of the tracepoint in the persistent storage medium further includes asynchronously persisting tracepoint registration data that includes the unique identifier from an in-memory data structure to the persistent storage medium.

In some aspects, the techniques described herein relate to a method, further including: generating executable code from source code, including a tracepoint generator searching the source code for a tracepoint macro and inserting the tracepoints at locations in the source code associated with the tracepoint macro; executing, during a runtime session corresponding to the first test, first executable code generated from the first version of the source code; counting a number of unique tracepoints activated during the runtime session to generate a first count, wherein the second information includes the first count and the analysis result depends on the first count; and determining, based on the first count, whether the code coverage of the first test is insufficient and additional testing is to be performed for the first version of the source code, wherein determining that the additional testing is to be performed for the first version of the source code is based on a comparison of the first count to a second count representing a number of tracepoints in the first set of the tracepoints to determine a code coverage metric of the first test relative to a historical coverage data, such that when the code coverage metric does not satisfy one or more code coverage criteria (e.g., does not exceed a predefined code coverage threshold) a determination is made to perform the additional testing.

In some aspects, the techniques described herein relate to a method, further including: performing the additional testing by continuing the runtime session of the first test until the second count has increased enough that the code coverage metric satisfies the one or more code coverage criteria.

In some aspects, the techniques described herein relate to a method, wherein the analysis result includes a comparison between unique identifiers of the first set of the tracepoints with the unique identifiers of respective tracepoints of the second set of the tracepoints (e.g., determining which of the first set of the tracepoints were not activated during a runtime session of the first test).

In some aspects, the techniques described herein relate to a method, wherein the method further includes: using the analysis result to generate synthetic test data directed to testing parts of the first version of the source code corresponding to tracepoints of the first set of the tracepoints that are to determined were not activated during the runtime session of the first test, and during a continuation of the first test, processing the synthetic test data using the first version of the source code and increasing the second set of the tracepoints to include tracepoints that have been activated during the second period spanning the first test, including the continuation of the first test.

In some aspects, the techniques described herein relate to a method, wherein the first test is performed in a production environment using actual user data in realtime.

In some aspects, the techniques described herein relate to a method, further including embedding, in source code, the tracepoints, wherein the tracepoints respectively have unique identifiers, and the tracepoints are embedded using a macro that generates the unique identifiers based on compile-time parameters; registering, in a persistent memory upon first being executed, the unique identifier of an executed tracepoint to provide historical tracepoint data; performing the first test of the first version of the source code by executing an executable program based on the first version of the source code and maintaining a first count of activated tracepoints during a runtime session as the first set of the tracepoints, wherein the activated tracepoints are a set of the tracepoints that are activated at least once during the runtime session; analyzing the first count and a second count representing how many tracepoints are in the first set of the tracepoints to provide a ratio as a code-coverage metric as the analysis result.

In some aspects, the techniques described herein relate to a method, further including: performing the first test of the first version of the source code by executing an executable program based on the first version of the source code.

In some aspects, the techniques described herein relate to a method, wherein: the first test is performed on a shadow dataplane of a multi-dataplane architecture in which the shadow dataplane executes logic instructions based on the first version of the source code and a primary dataplane of the multi-dataplane architecture performs other logic instructions based on a second version of the source code, the first version of the source code is a next version of the source code, and the second version of the source code is an earlier version of the source code, which was written before the next version of the source code.

In some aspects, the techniques described herein relate to a computing apparatus including: one or more processors; and a memory storing instructions that, when executed by the processor, configure the apparatus to: perform any of the above-recited methods.

A non-transitory computer-readable storage medium, the non-transitory computer-readable storage medium including instructions that when executed by a computer, cause the computer to perform any of the above-recited methods.

### EXAMPLE EMBODIMENTS

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improvements in determining code coverage for testing software, firmware, or other forms of logic instructions. Other code coverage metrics can operate under the assumption that all code paths are equally reachable and that, with sufficient testing, each embedded tracepoint should eventually be executed. These metrics typically focus on achieving high percentages of line, branch, or function coverage, with the implicit goal of hitting every measurable part of the codebase. While this model is well-suited to controlled development or QA environments, it may not reflect the realities of complex production systems, where the activation of certain code paths depends on specific configurations, feature flags, deployment contexts, or runtime conditions.

In many production scenarios, certain tracepoints are associated with optional or unused features, hardware-specific logic, or corner-case error handling that may never be triggered under normal operating conditions. As a result, coverage metrics derived under the expectation of activating the total set of tracepoints might not be very useful. To address this, it is valuable to adopt a dynamic and context-aware approach that uses, as a baseline, the tracepoints that have been activated in real-world environments over time.

By capturing and analyzing the subset of tracepoints that are actively exercised in a given deployment/environment, it becomes possible to generate more environment-specific coverage metrics. This approach allows engineering teams to evaluate test completeness against the actual behavior of software in production, rather than an idealized or static model. This method does not preclude broader coverage goals (e.g., in the staging phase of testing) but complements them by aligning coverage analysis (e.g., during production phase testing) with practical usage patterns.

By dynamically generating tracepoints within the source code and calculating environment-specific code coverage, it is possible to better determine whether the testing has reached all relevant branches of the source code. According to certain non-limiting examples, programs can insert a tracepoint macro within each branch of code that the programmer writes. Then a tracepoint generator that runs as part of the build process can identify the inserted macros and insert a tracepoint. Compile-time parameters such as the file and line number of the tracepoint can be used as unique identifiers of the respective tracepoints.

According to certain non-limiting examples, the system and methods disclosed herein dynamically generate tracepoints in source code and track which of these tracepoints are activated in an environment-specific production system. The systems and methods disclosed herein then calculate a code coverage metric based on the proportion of tracepoints hit in the current session relative to the unique set of tracepoints historically activated in the environment, providing a more accurate reflection of real-world code usage. This approach enables a more accurate assessment of the completeness of the testing in a production environment by providing a code-coverage metric that reflects actual operational conditions, as opposed to a static, unrealistic benchmark.

According to certain non-limiting examples, the system and methods disclosed herein dynamically generate and register tracepoints within source code by leveraging unique compile-time identifiers, building a persistent record of the code paths that are executed in a particular environment. The systems and methods disclosed herein can use the record of the registered tracepoints to calculate an environment-specific code coverage value based on the historical and real-time tracepoints hit, providing a more accurate and operationally relevant measure of software quality and testing completeness.

According to certain non-limiting examples, tracepoints are dynamically generated in code, and the tracepoints are generated to automatically capture unique identifiers during compilation. For example, a macro can be defined that uses parameters such as “_FILE_” and “__LINE__” that signal to the tracepoint generator, which runs as part of the build process, to include compile time parameters for the file and line of the tracepoint function call.

According to certain non-limiting examples, the historic log of tracepoints can be generated by having each tracepoint, upon its first execution, register itself with a persistent registry, thereby building a historical log of tracepoints that have been active in that specific environment. The historical log can represent, for example, all tracepoints that have been activated.

According to certain non-limiting examples, during any runtime session, such as when testing a new version of the source code, the system counts the tracepoints that are activated/executed and calculates an environment-specific code coverage metric using the ratio of the count of tracepoints hit during the session to the total number of unique tracepoints recorded historically. This method enables more meaningful quality metrics that reflect the actual code paths exercised by the end-user in their environment.

According to certain non-limiting examples, the tracepoints can be dynamically generated using a macro placed within respective branches of the source code. The systems and methods disclosed herein embed tracepoints in source code via a macro (e.g., TRACEPOINT( ) for which an example is provided below). This macro is designed to generate a unique identifier by incorporating compile-time information such as the file name and line number. For example, the macro can be defined using the following pseudocode:

#define TRACEPOINT( ) TRACEPOINT_INTERNAL(_{——}FILE_{——}, _{——}LINE_{——})

According to certain non-limiting examples, the internal macro, TRACEPOINT_INTERNAL, then performs the registration of the tracepoint. Upon execution, the TRACEPOINT_INTERNAL macro checks if the tracepoint has already been registered (e.g., using a static flag and a mutex for thread safety). If the tracepoint has not already been registered, the internal macro, TRACEPOINT_INTERNAL, calls a registration function, such as defined in the following pseudocode:

```
static void register_tracepoint(const char *file, int line) {
// Locking for thread safety
pthread_mutex_lock(&tracepoint_mutex);
// Check for prior registration in an in-memory structure
// If not present, add the unique identifier and persist it
  if (!is_tracepoint_registered(file, line)) {
    add_tracepoint_to_memory(file, line);
    persist_tracepoint(file, line);
  }
  pthread_mutex_unlock(&tracepoint_mutex);
}
```

The persistence step writes the unique identifier to a file or database so that the system builds an ongoing record of tracepoints that have ever been activated in that particular environment.

According to certain non-limiting examples, the systems and methods disclosed herein dynamically calculate the code coverage using a ratio a first set of tracepoints (e.g., the number of tracepoints that have been activated at least once during the runtime session testing a current version of the source code in a particular environment) divided by second set of tracepoints (e.g., the number of tracepoints that have been activated at least once throughout the history of the source code in the particular environment). According to certain non-limiting examples, the numerator of the ratio can be a counter of tracepoints hit during the current runtime session. According to certain non-limiting examples, the denominator of the ratio can be the total number of unique tracepoints registered historically (e.g., the persistent record). Thus, the environment-specific code coverage can be calculated as:

$$Coverage = ( {N}_{Test} / {N}_{Hist} ) \times 100 \% ,$$

wherein N_{Test} is the number of tracepoints hit in current session and N_{Hist} is the number of unique tracepoints registered. This code-coverage metric is dynamic in the sense that it adapts over time, ensuring that code coverage reflects the operational reality of the environment rather than the entire static set of tracepoints present in the codebase.

According to certain non-limiting examples, the system and methods disclosed herein asynchronously log and batch the tracepoint registrations to reduce the performance overhead. For example, registering tracepoints in the historic log can be performed by asynchronously persisting tracepoint registration data from an in-memory data structure to the persistent storage medium.

According to certain non-limiting examples, a background service can periodically flush the in-memory tracepoint data to persistent storage.

According to certain non-limiting examples, the system and methods disclosed herein can be integrated in an automated testing framework such that the environment-specific code coverage metric can be used to drive further testing or alerting. For example, to determine when testing is concluded, the test can include a step of periodically inquiring whether the code-coverage metric satisfies one or more code-coverage criteria (e.g., does the code coverage exceed a predefined threshold of 90%, for example). When the code-coverage metric does not satisfy the code-coverage criteria, testing continues and the inquiry is performed again after another testing period.

According to certain non-limiting examples, when the inquiry returns a value indicating that the code-coverage metric satisfies the code-coverage criteria, an alert can be sent to communicate the code-coverage metric has been satisfied. Responsive to the alert, an administrator of the test can review other metrics of the test and choose to conclude the test or continue the test if unresolved questions remain or if more confidence in the test results are desired. Alternatively, the test can automatically conclude when the code-coverage criteria and other testing criteria (if any) are also satisfied.

A historical log of all tracepoints that have been executed over the history of the software (e.g., for previous versions of the source code) within a particular context/environment can be used as a baseline for determining a code-coverage metric. Consider a non-limiting example of testing software/logic instructions based on source code for Internet protocol (IP) data packet processing, wherein source code includes some branches that are specific to IPv6 packets, some branches that are specific to IPv4 packets, and other branches that are used for both types of packets. Before upgrading the version of the software/logic instructions, a customer may test the new version in the actual environment where it is deployed to detect and mitigate potential problems with rolling out and deploying the new version. This testing in the client's production environment can be performed after a full range of testing in a staging environment.

When the client's production environment does not process or use IPv6 packets, the IPv6-specific branches in the source code will not be exercised during production-environment testing, resulting in the challenge of determining when the production testing has continued long enough to test the relevant part of the source code. 100% code coverage would not be expected because the IPv6-specific branches in the source code will not be exercised, which leaves the question what percentage of code coverage should be the criteria for the production-environment testing. The systems and methods disclosed herein answer this question by using the historical log for the particular production environment to dynamically determine a baseline code coverage for the particular production environment. The systems and methods disclosed herein are dynamic in the sense that the historical log can change and grow with the source code versions and changes in the environment. Further, the systems and methods disclosed herein are dynamic in the sense that the historical log can be different for different production environments. Also, the systems and methods disclosed herein can dynamically generate tracepoints throughout the production code.

As discussed above, the code-coverage baseline for source code can depend on the production environment in which it is deployed (e.g., evaluating code coverage for IPv6-compatible software operating in an IPv4 environment), resulting in a challenge when determining the code-coverage baseline for testing source code in different environments. Returning to the example of evaluating code coverage for IPv6-compatible software operating in an IPv4 environment, the systems and methods disclosed herein can dynamically generate tracepoints throughout the production code. These tracepoints serve as indicators of which code paths have been exercised during execution. For example, one thousand tracepoints might be inserted across various branches of the codebase, and the software is then executed in a production setting.

The objective is to determine how much of the code has been exercised during the testing phase. However, many of these tracepoints may reside in exception-handling branches, inactive features, or code paths that are rarely or never executed. For instance, if three hundred of the one thousand tracepoints are specific to IPv6 functionality and the system is operating in an IPv4-only environment, those tracepoints will never be hit, making 100% code coverage unattainable.

In contrast to staging phase testing in traditional quality assurance (QA), in which the goal is often to achieve full code coverage, the emphasis in production-phase testing is on measuring coverage for the portions of the code that are actively used in production. The idea is to dynamically insert tracepoints into production code and monitor which ones are executed over time for a given customer deployment.

After an extended period—such as one year—of monitoring production use, it may be observed that seven hundred of the original one thousand tracepoints have been triggered. This subset then becomes the reference set for production-level code coverage. During future testing or qualification efforts, the baseline for production testing is the seven hundred code paths that have been exercised, historically. Code coverage of this production-derived set of tracepoints provides high confidence that the relevant parts of the source code have been tested, even if the remaining three hundred tracepoints—associated with unused or disabled features—have not been tested. This method allows for a practical and usage-focused definition of code coverage, ensuring that testing efforts align with real-world usage and customer-relevant features.

According to certain non-limiting examples, the systems and methods disclosed herein can be used for testing software/logic instructions network components and network functions, such as embedded devices and edge-computing devices (e.g., routers, switches, firewall appliances, network control appliances, etc.) For example, the source code can apply to software in the control plane, management plane, or data plane of an edge-computing device. More generally, the systems and methods disclosed herein can be used anywhere source code is developed where a dynamic code coverage metric can be used to improve the determination of the efficacy of the testing and/or the duration of the testing phase, as would be understood by a person of ordinary skill in the art.

For example, a major challenge facing embedded devices at the network edge is the inability to seamlessly upgrade the embedded devices. These edge-computing devices can include a control plane that controls a dataplane in which data packets are received at various ports, interacted with in some manner (e.g., filtered, routed, forwarded, processed through a firewall, etc.), and then transmitted from the various ports, as discussed below.

Generally, upgrading an edge-computing device presents several challenges. First, downtime can result from upgrading the edge-computing device due to device failover and/or route re-convergence. Accordingly, a maintenance window can be scheduled, and the upgrade performed during the maintenance window to allow for the above-noted contingencies. Second, to ensure that the new software or policy does not have negative effects on the network, exhaustive pre-upgrade checks and post-upgrade checks can be performed on the edge-computing device or network component. Third, in case of upgrade failures, a rollback and other contingency plans can be used to rectify the upgrade failures. Fourth, the upgrade can be accompanied by uncertainty about issues in the new version. For example, uncertainty about issues in the new version might not have been identified in quality assurance (QA) checks. In some cases, for example, during the staging/testing phase, the testing environment used to initially verify the new version may be different than the customer's own network on which the new version is ultimately applied (e.g., the production/deployment phase). These differences may be due to unique characteristics of the customer's own network.

The systems and methods disclosed herein address the above-noted challenges by providing an improved technique for determining code coverage during production-phase testing, such as when using dual dataplanes (e.g., a primary dataplane and a shadow dataplane) to perform digital-twin testing. For example, the primary dataplane executes a current version of the software or network policy, and the shadow dataplane executes a new version of the software or network policy. The shadow dataplane is used to perform verification testing of the new version by comparing its performance to that of the current version. Thus, the upgrade can undergo verification testing in the same environment as the current version is operating in (i.e., the customer's own network). Using the improved code-coverage metric provided by the system and methods disclosed herein, it is possible to better determine when the verification testing has proceeded sufficiently long to provide a high degree of confidence in the test results thereby minimizing uncertainty about issues in the new version that may not have been identified in QA due to unique characteristics of the customer's own network.

Further, because the new version is verified in the shadow dataplane rather than the primary dataplane, the need for rollback and other contingency plans in case of upgrade failures can be largely mitigated. That is, until the verification testing is complete and the new version is promoted to the primary dataplane, the current version continues to operate in parallel with the new version, and the network functionality continues to be performed by the current version rather than the new version. Then during promotion, which occurs after the new version passes verification testing, the new version can be gradually and gracefully transitioned to assuming the role of the new primary dataplane (i.e., the function of the network device is taken over by the new version). For example, if the new version fails the verification testing, there is no need to roll back to the current version because the current version is still operating to provide the functionality of the edge-computing device, unless and until the new version passes the verification testing. Further, the assurances provided by the pre-upgrade checks and post-upgrade checks can be (largely) integrated into the verification testing. Moreover, because the verification testing occurs in the background and is not disruptive to users, the upgrade can occur at any time rather than during a scheduled maintenance window.

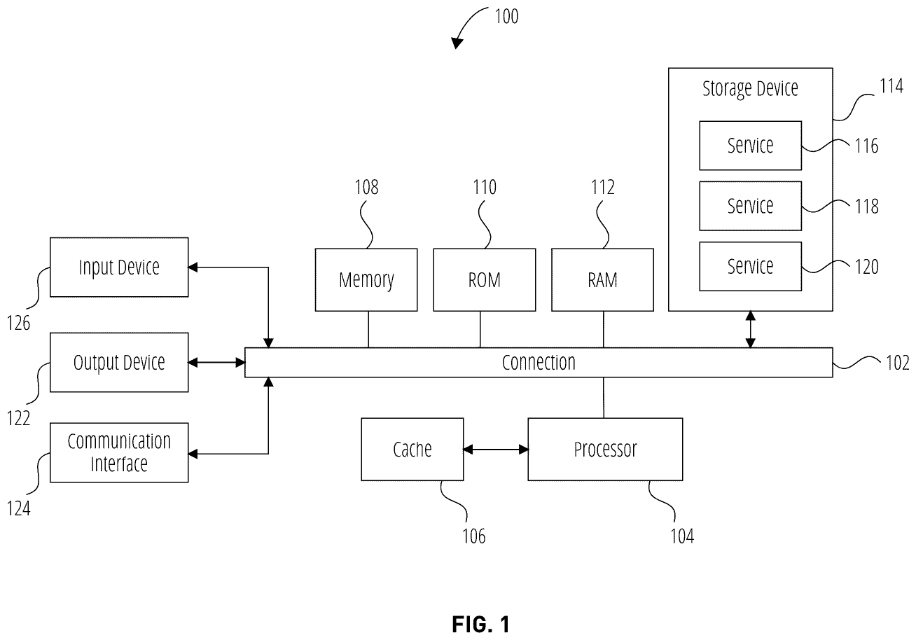

FIG. 1 shows an example of computing system 100. The computing system 100 can be a router, switch, network control appliance, network management appliance, or an analytics engine, for example. Computing system 100 can be part of a distributed computing network in which several computers perform respective steps in method 200. The computing system 100 can be connected to the other parts of the distributed computing network via connection 102 or communication interface 124. Connection 102 can be a physical connection via a bus, or a direct connection into processor 104, such as in a chipset architecture. Connection 102 can also be a virtual connection, networked connection, or logical connection.

In some embodiments, computing system 100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 100 includes at least one processing unit or CPU (e.g., processor 104) and connection 102 that couples various system components including system memory 108, such as read-only memory (e.g., ROM 110) and random access memory (e.g., RAM 112) to processor 104. Computing system 100 can include a cache of high-speed memory 106 connected directly with, in close proximity to, or integrated as part of processor 104. Processor 104 may essentially be a completely self-contained computing system, containing multiple cores or processors, a bus, memory controller, cache, etc. A multi-core processor may be symmetric or asymmetric.

Processor 104 can include any general-purpose processor and a hardware service or software service, such as service 116, service 118, and service 120 stored in storage device 114, configured to control processor 104 as well as a special-purpose processor where software instructions are incorporated into the actual processor design.

To enable user interaction, computing system 100 includes an input device 126, which can represent any number of input mechanisms, such as a microphone for speech, a touch-sensitive screen for gesture or graphical input, keyboard, mouse, motion input, speech, etc. Computing system 100 can also include output device 122, which can be one or more of a number of output mechanisms known to those of skill in the art. In some instances, multimodal systems can enable a user to provide multiple types of input/output to communicate with computing system 100. Computing system 100 can include a communication interface 124, which can generally govern and manage the user input and system output. There is no restriction on operating on any particular hardware arrangement, and therefore the basic features here may easily be substituted for improved hardware or firmware arrangements as they are developed.

Storage device 114 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 114 can include software services, servers, services, etc., that when the code that defines such software is executed by the processor 104, it causes the system to perform a function. In some embodiments, a hardware service that performs a particular function can include the software component stored in a computer-readable medium in connection with the necessary hardware components, such as processor 104, connection 102, output device 122, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of computing system 100 and performs one or more functions of method 200 when a processor executes the software associated with the service. In some embodiments, a service is a program or a collection of programs that carry out a specific function. In some embodiments, a service can be considered a server. The memory can be a non-transitory computer-readable medium.

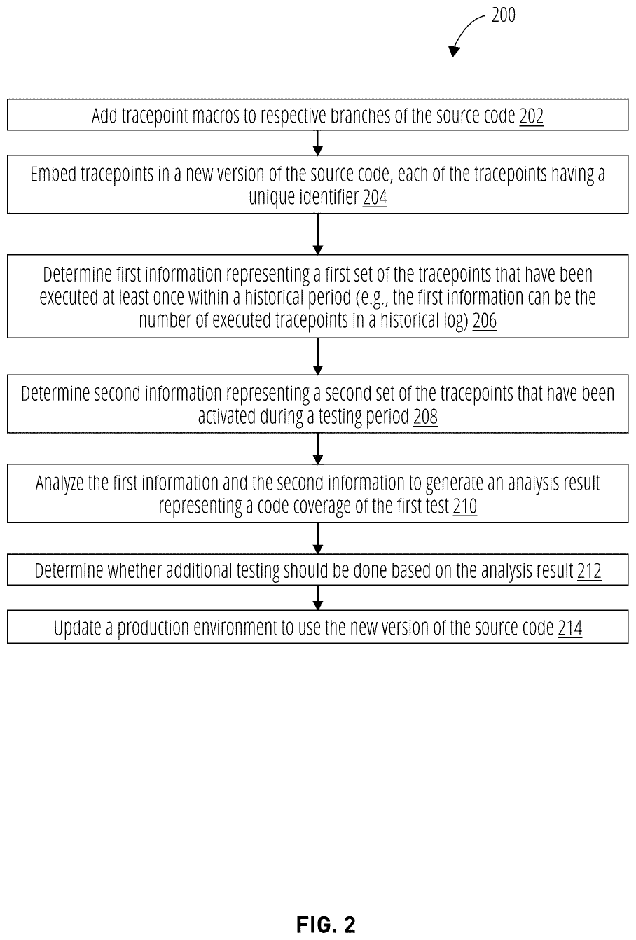

FIG. 2 illustrates an example method 200 for dynamically calculating environment-specific code coverage. Although the example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements method 200 may perform functions at substantially the same time or in a specific sequence.

Method 200 can dynamically generate tracepoints within source code and calculate an environment-specific code coverage. According to certain non-limiting examples, each tracepoint is generated via a macro that incorporates compile-time information (e.g., file name and line number) to create a unique identifier. When executed, each tracepoint registers itself in persistent storage, unless it has been previously recorded. According to certain non-limiting examples, the code coverage can be calculated as the ratio of tracepoints activated in a current runtime session to the total set of tracepoints that have historically activated in that environment. This dynamic approach allows code coverage metrics to reflect the operational usage in the environment, as opposed to a static code model.

According to some examples, block 202 of the method includes adding tracepoint macros to respective branches of the source code. For example, processor 104 illustrated in FIG. 1 may add tracepoint macros to respective branches of the source code.

According to some examples, the method of block 204 includes embedding tracepoints in a new version of the source code, each of the tracepoints has a unique identifier. For example, processor 104 illustrated in FIG. 1 may embed tracepoints in a new version of the source code. Each of the tracepoints has a unique identifier. The unique identifier can be, for example, a file name and a line number of the tracepoint.

According to certain non-limiting examples, a macro is added to respective branches of the first version of the source code (e.g., a program update). A code generator inserts respective tracepoint function calls at each place where the tracepoint macro is located. The macro generates a unique identifier for each of the tracepoints (e.g., the file name and the line number of the tracepoint). For example, the macro can generate the unique identifier by incorporating compile-time information such as the file name and line number.

According to certain non-limiting examples, a compiler processes the source code to generate executable code from the first version of the source code. The tracepoint generator searches the source code for a tracepoint macro and inserts the tracepoints at locations in the source code associated with the tracepoint macro. And the first set of the tracepoints is tested by executing the executable code in a runtime session in a particular environment (e.g., a production environment using the customer's data).

According to some examples, block 206 of the method includes determining first information (e.g., a count) representing a first set of the tracepoints that have been executed at least once within a historical period (e.g., the first information can be the number of executed tracepoints in a historical log). For example, processor 104 illustrated in FIG. 1 may determine the first information representing the first set of the tracepoints that have been executed at least once within a historical period.

According to certain non-limiting examples, the historical log includes tracepoints that have been executed at least once during runtime sessions for at least one previous version of the source code and during a current test of the new version of the source code. The historical log is generated by registering the executed tracepoints when they are first executed.

For example, the executed tracepoints can be registered by storing the unique identifiers of the executed tracepoints in a persistent memory. A first count of tracepoints represents how many tracepoints are registered in the historical log.

Determining the number of tracepoints registered in the historical log is dynamic because the first set of the tracepoints dynamically grows to provide an environment-specific code coverage. According to certain non-limiting examples, the historical period (also referred to as the first period) can begin at a start time when an earlier version of the source code is being used in a production environment, and the historical period can be open-ended with respect the end time, such that newly executed tracepoints continue to be added to the first set of the tracepoints (i.e., the historical log). Thus, the historical log is dynamic in the sense that it continues to grow as runtime sessions for one or more versions of source code cause additional tracepoints to be executed within the particular environment (e.g., the production environment).

The historical log can grow dynamically to reflect the actual environment, such that the count of relevant/executed tracepoints continuously grows to reflect changes in the environment and/or changes to the versions of the source code. For example, if the source code has one thousand tracepoints, but only seven hundred of the tracepoints have been registered in the historical log, then this particular environment may have characteristics/policies that result in certain branches of the source code never being exercised. For example, if the environment only uses IPv4, then branches of the source code that are limited to IPv6 will not be exercised. For this particular environment, the proper point of comparison is seven hundred tracepoints—not the one thousand possible tracepoints. If something changes in this environment, such as changing a policy to handle/use both IPv4 and IPv6 data packets, then the registered tracepoints in the historical log may dynamically increase to reflect the changes in the environment.

Thus, the historical log can represent a universe of tracepoints that are relevant for the source code in the particular environment. The historical period can include both the testing period during which the new version of the source code is executed, as well as an earlier historical period during which one or more previous/current versions of the source code are executed. In contrast, the testing period only includes one or more runtime sessions during which the new version of the source code is executed.

According to certain non-limiting examples, ensuring each of the tracepoints is registered at most once can be achieved by defining a registers-tracepoint function that registers a tracepoint only upon a first time the tracepoint is executed. For example, the registers-tracepoint function can be defined using a static flag and a mutual exclusion (mutex) synchronization primitive that provides thread safety.

According to certain non-limiting examples, storing the unique identifier of the tracepoint in the persistent storage medium includes asynchronously persisting tracepoint registration data (e.g., the unique identifier) from an in-memory data structure to the persistent storage medium.

According to some examples, block 208 of the method includes determining second information representing a second set of the tracepoints that have been activated during a testing period. For example, processor 104 illustrated in FIG. 1 may determine the second information representing the second set of the tracepoints that have been activated during the testing period.

According to certain non-limiting examples, the second information can be determined by performing a runtime session to test the first version of the source code. The second information can include a second count that is dynamically generated by maintaining a running tally of the number of the tracepoints that are activated at least once during the runtime session of the testing period. Determining the second information includes counting the set of the tracepoints that are activated during a runtime session of the testing period, to provide a second count representing how many tracepoints are in the second set of the tracepoints. Both the first and second sets of tracepoints can be generated in the same environment. For example, the first test can be performed in a production environment using actual user's data in real time.

According to certain non-limiting examples, the source-code test is performed on a shadow dataplane of a multi-dataplane architecture in which the shadow dataplane executes logic instructions based on the first (new) version of the source code and a primary dataplane of the multi-dataplane architecture performs other logic instructions based on a second (previous) version of the source code. That is, the first version of the logic instructions or software on the shadow dataplane is generated using the new version of the source code, and the second version of the logic instructions or software on the primary dataplane is generated using a previous version of the source code.

According to some examples, block 210 of the method includes analyzing the first information and the second information to generate an analysis result representing a code coverage of the source-code test. For example, processor 104 illustrated in FIG. 1 may analyze the first information and the second information to generate an analysis result representing a code coverage of the source-code test.

For example, the analysis result is based, at least partly, on a ratio between the second count and the first count. The analysis result is dynamic because the information (e.g., the first and second counts) it is based on is dynamic. For example, the ratio of the activated tracepoints during the source-code test is the ratio of the second count (e.g., the number of activated tracepoints during the test) divided by the first count (e.g., the total number of executed tracepoints in the historical log). The total number of executed tracepoints dynamically grows making the analysis result of the code coverage for the current test a dynamic analysis result.

According to some examples, block 212 of the method includes determining whether additional testing should be done based on the analysis result. For example, processor 104 illustrated in FIG. 1 may determine whether additional testing should be done based on the analysis result.

According to certain non-limiting examples, determining that the additional testing is to be performed for the first version of the source code is based on a comparison of the first count to a second count representing a number of tracepoints in the first set of the tracepoints to determine a code coverage metric of the first test relative to a historical coverage data. When the code coverage metric does not satisfy one or more code coverage criteria (e.g., does not exceed a predefined code coverage threshold) a determination is made to perform the additional testing. The additional testing is performed by continuing the runtime session of the source-code test until the code coverage metric satisfies the one or more code coverage criteria.

According to certain non-limiting examples, determining that the additional testing is to be performed for comparing the first set of tracepoints (e.g., the tracepoints that have been activated at least once during a current runtime session testing a current version of the source code in a particular environment) with the second set of tracepoints (e.g., the tracepoints that have been activated at least once throughout the history of the source code in the particular environment) to determine which tracepoints from the second set have not been activated during the current runtime session to provide a set of untested tracepoints for the current runtime session. For example, the set of untested tracepoints can be a list of the unique identifiers of tracepoints in the set of untested tracepoints. The unique identifiers of the tracepoints in the set of untested tracepoints can be used with a lookup table or other reference that associates a unique identifier of a tracepoints with a functionality of a branch of the source code in which the tracepoint is located. For example, when the unique identifier includes a file and line, a machine learning (ML) language model can use the file and line to identify the branch of the source code, interpret and/or summarize its functionality, and recommend synthetic test data/traffic that would activate the identified branch of the source code. The recommended synthetic test data/traffic can be used to perform additional testing during the current runtime session of the source-code test to increase the code coverage, until the code coverage metric satisfies the one or more code coverage criteria. For example, processing the recommended synthetic test data/traffic can be used to perform additional testing that causes the first set of tracepoints to be coextensive with the second set of tracepoints (e.g., 100% code coverage based on the ratio between the number of tracepoints in the first set of tracepoints compared to the number of tracepoints in the second set of tracepoints.

According to some examples, block 214 of the method includes updating a production environment to use the new version of the source code. For example, processor 104 illustrated in FIG. 1 may update a production environment to use the new version of the source code. In a production environment, a previous version of a program or logic instructions (e.g., executable code) is replaced by the new version, which is based on the new version of the source code.

This swapping in of the new version occurs when the code coverage metric for the testing (e.g., the first testing and the additional testing) satisfies one or more coverage criteria and the testing also satisfies one or more validation criteria (e.g., no bugs are detected).

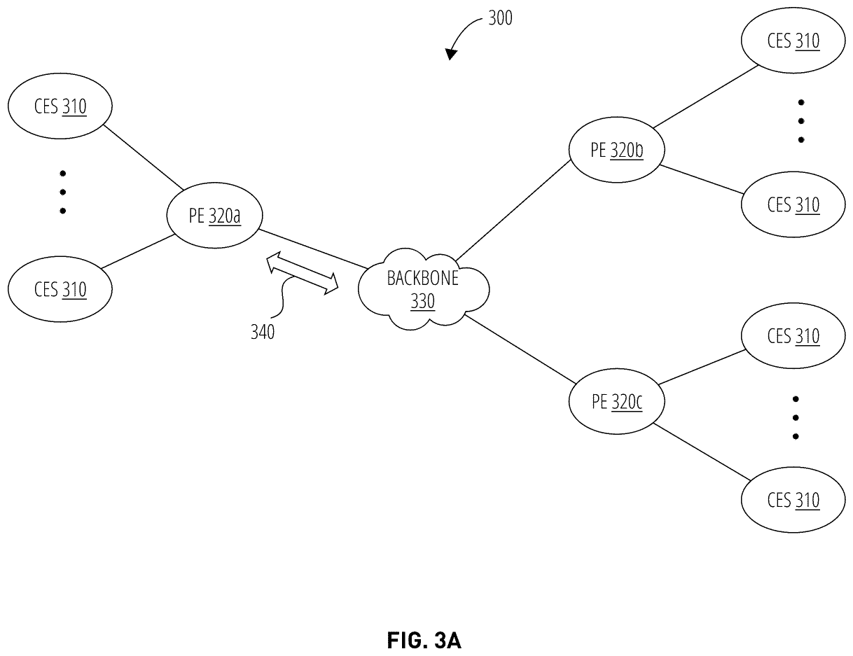

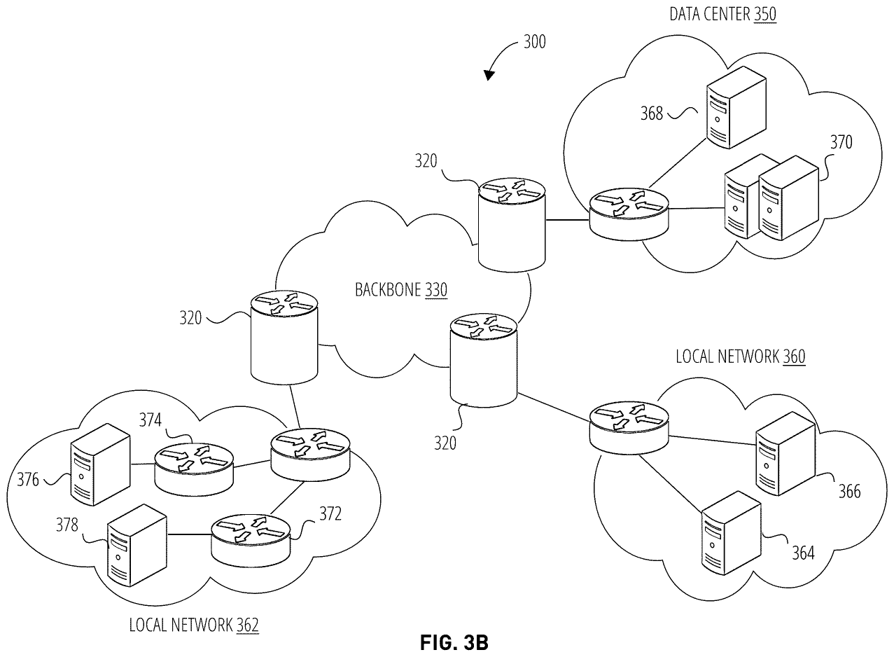

FIG. 3A illustrates an example of a computer network environment in which method 200 can be used to upgrade software and/or firmware of the respective components, including, for example, routers, switches, firewalls, network control appliances, network management appliances, servers, etc. The source code can implement network functions, dataplane function, management function, or control-plane functions, for example.

A computer network environment is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

FIG. 3A is a schematic block diagram of a non-limiting example of a computer network 300 that includes various nodes/devices, such as a plurality of routers/devices interconnected by links or networks. For example, customer edge (CE) routers (e.g., CEs 310) may be interconnected with provider edge (PE) routers (e.g., PE 320a, PE 320b, and PE 320c) to communicate across a core network, such as network backbone 330. For example, the routers (e.g., CEs 310, PEs 320) may be interconnected by the public Internet, a multiprotocol label switching (MPLS), or a virtual private network (VPN). Data packets 340 (e.g., traffic/messages) may be exchanged among the nodes/devices of the computer network 300 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics.

FIG. 3B illustrates an example of computer network 300 in greater detail, according to various embodiments. As shown, network backbone 330 may provide connectivity between devices located in different geographical areas and/or different types of local networks. For example, computer network 300 may comprise local/branch networks (e.g., branch network 360 and branch network 362) that include devices/nodes 372, 374, 376, and 378 and devices/nodes 364 and 366, respectively, as well as a data center 350 that includes servers 368 and 370. Notably, local network 360, local network 362, and data center 350 can be located in different geographic locations.

Server 368 and server 370 can include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 300 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

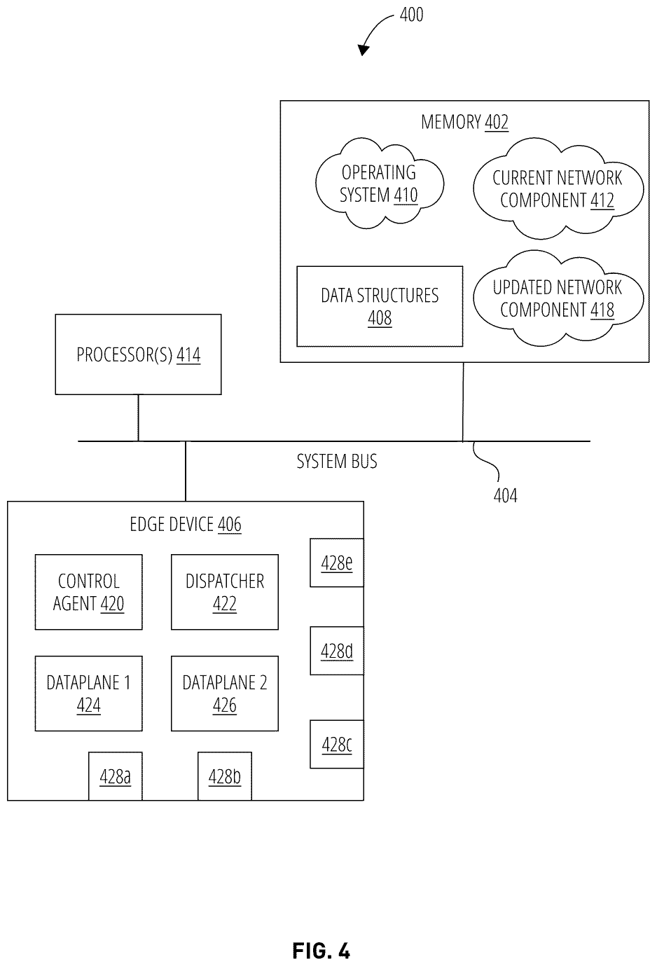

FIG. 4 is a schematic block diagram of an example node/device 400 (e.g., an apparatus) that may be used with one or more embodiments described herein, e.g., as any of the computing devices shown in FIG. 3A and FIG. 3B, device 400 may also be any other suitable type of device depending upon the type of network architecture in place, such as IoT nodes, etc. Device 400 can include one or more edge devices (e.g., edge device 406), one or more processors (e.g., processor 414), and a memory 402 interconnected by a system bus 404.

Edge device 406 can include the mechanical, electrical, and signaling circuitry for communicating data over physical links coupled to computer network 300. Edge device 406 can be configured to transmit and/or receive data using a variety of different communication protocols. Edge device 406 can also be used to implement one or more virtual network interfaces, such as for virtual private network (VPN) access, known to those skilled in the art. Edge device 406 can be implemented as software executed on a central processing unit (CPU), such as a virtual machine like a Berkley packet filter (BPF) or extended BPF (eBPF) that is configured to implement a network policy, for example. Alternatively or additionally, Edge device 406 can be implemented as a separate piece of hardware (e.g., a data processing unit (DPU), a graphics processing unit (GPU), a smart network interface card (smartNIC), a network interface controller, an application-specific integrated circuit (ASIC), field programable gate array (FPGA), or other device/circuitry configured to perform the function of a network component).

Edge device 406 can be configured to provide one or more network functions, including, e.g., data-packet filtering, load balancing, packet screening, pattern detection for cybersecurity threats, malware detection, firewall protection, data-packet routing, data-packet switching, data-packet forwarding, computing header checksums, or implementing network policies. According to certain non-limiting examples, edge device 406 can be an embedded device at the network edge. Edge device 406 can include (or be part of) a software-defined wide area network (SD-WAN) appliance, a firewall, or a load balancer, for example. Moreover, the systems and methods disclosed herein can be used with any edge device 406 that includes a dataplane that can be intermittently updated to a new version.

Edge device 406 can include a dataplane, a control plane, and a management plane, as discussed above. Further, instructions implementing the control plane and the management plane can be stored and/or executed in processor 414. Additionally or alternatively, the edge device 406 can include processors or circuits that implement one or more functions of the control plane and the management plane. Edge device 406 can include a series of ports (e.g., port 428a, port 428b, port 428c, port 428d, and port 428e). Edge device 406 can also include a control agent 420, a dispatcher 422, a dataplane 424, and a dataplane 426.

Memory 402 can include a plurality of storage locations that are addressable by processor 414 and edge device 406 for storing software programs and data structures associated with the embodiments described herein. Memory 402 can include data structures 408 and can include instructions for executing operating system 410, current network component 412, and the updated network component 418. Processor 414 can include logic adapted to execute the software programs and manipulate the data structures 408. An operating system 410 (e.g., the Internetworking Operating System, or IOS®, of Cisco Systems, Inc., another operating system, etc.), portions of which can be in memory 402 and executed by the processor(s), functionally organizes the node by, inter alia, invoking network operations in support of software processors and/or services executing on the device.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

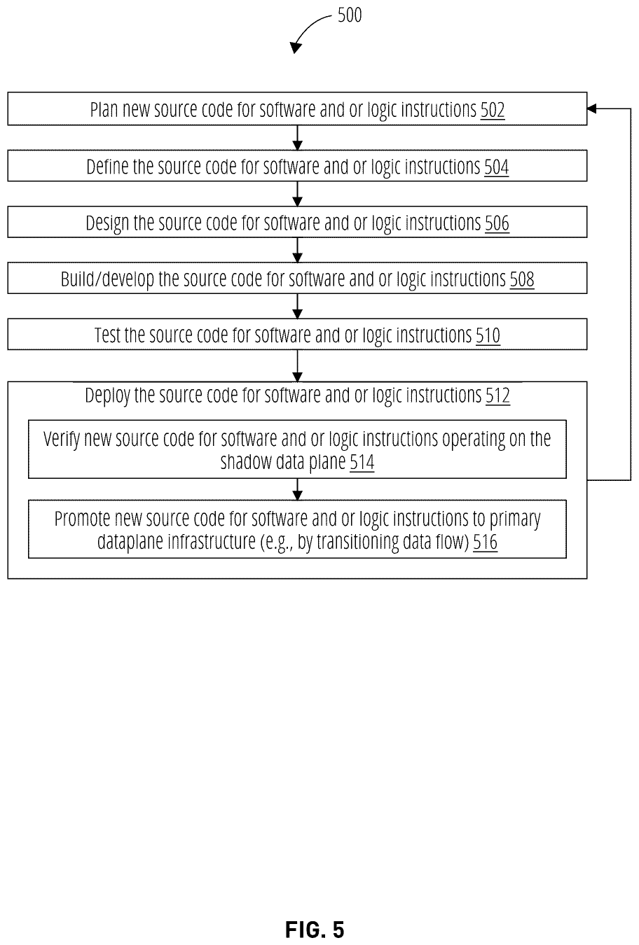

FIG. 5 illustrates an example of method 500 for a software development life cycle (SDLC). Although the example method 500 depicts a particular sequence of operations, the sequence may be altered without departing from the scope of the present disclosure. For example, some of the operations depicted may be performed in parallel or in a different sequence that does not materially affect the function of method 500. In other examples, different components of an example device or system that implements method 500 may perform functions at substantially the same time or in a specific sequence.

Method 500 provides a structured process to enable high-quality, low-cost dataplane development in a short period. Method 500 can produce a source code for software and or logic instructions that meets customer expectations with minimal interruption.

According to some examples, in step 502, the method includes planning new source code for software and or logic instructions.

According to certain non-limiting examples, step 502 includes planning and requirement analysis. Requirement analysis can be performed by the senior members of the team with inputs from the customer, the sales department, market surveys, and domain experts in the industry.

According to some examples, in step 504, the method includes defining the source code for software and or logic instructions at step 504.

According to certain non-limiting examples, upon completion of the requirement analysis, the product requirements can be defined and documented. Further, these product requirements can be approved by the customer or the market analysts. This can be done using a software requirement specification (SRS) document which consists of all the product requirements to be designed and developed during the project life cycle.

According to some examples, in step 506, the method includes designing the source code for software and or logic instructions at step 506.

According to certain non-limiting examples, the SRS is used as the reference for product architects to come out with the best architecture for the product to be developed. Based on the requirements specified in SRS. According to certain non-limiting examples, more than one design approach can be proposed for the product architecture is proposed and documented in a DDS—Design Document Specification.

This DDS is reviewed by various stakeholders and a preferred design approach is selected based on various selection criteria (e.g., based on various parameters such as risk assessment, product robustness, design modularity, budget, and time constraints). A design approach defines the architectural modules of the product along with its communication and data flow representation with the external and third-party modules (if any).

According to some examples, in step 508, the method includes building/developing the source code for software and or logic instructions at step 508.

According to certain non-limiting examples, in step 508 the development is performed and the product is built. The programming code is generated as per DDS during this step. Developers follow the coding guidelines defined by their organization and programming tools like compilers, interpreters, debuggers, etc. are used to generate the code. Different high-level programming languages such as C, C++, Pascal, Java and PHP are used for coding.

According to some examples, in step 510, the method includes testing the source code for software and or logic instructions at step 510.

According to certain non-limiting examples, step 510 can include parts of all stages of the SDLC cycle, and can thus be viewed as a subset of all the stages of the SDLC model. Further, some testing activities can be integrated with other stages of method 500. Once a code commit is ready, testing can proceed by provisioning the code commit in a staging environment that is intended to be representative of how the new version will be used in practice. Then, testing proceeds by measuring various signals to determine that the product/new version functions as desired. Generally, step 510 can include testing the product/new version for defects, bugs, or security vulnerabilities, and then reporting, tracking, fixing, and retesting the defects, bugs, or security vulnerabilities, until the product reaches the quality standards and passes a quality assurance (QA) process.

According to some examples, in process 512, the method includes deploying the source code for software and or logic instructions at process 512. Process 512 can include step 514 and step 516. In process 512, the new version/product can be deployed by provisioning it in a production environment (e.g., the customer's own network) and performing additional testing in this environment to ensure that the new version/product by measuring various signals to determine that the product/new version functions as desired.

According to some examples, in step 514, the method uses a twin testing in a production environment in which the new version is tested in parallel with the current version, but the outputs and results of the current version continue to be used until the new version has met various quality assurance (QA) checks. The twin testing can include a shadow implementation (e.g., a shadow dataplane) and a primary implementation (e.g., a primary dataplane). The primary implementation is used to perform the work of the system while the shadow implementation is used for testing.

The verification of the source code for software and or logic instructions in step 514 can be performed using method 200.

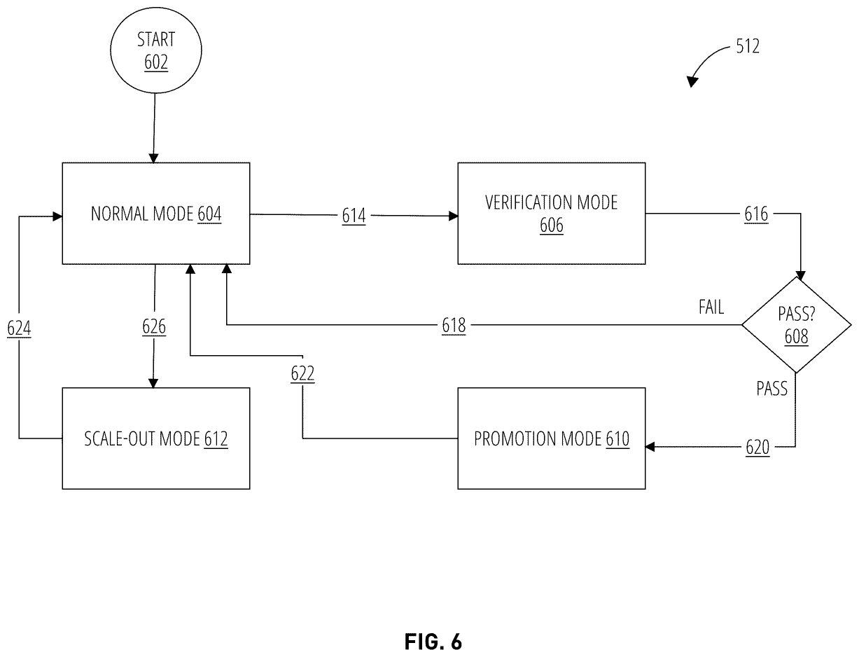

According to certain non-limiting examples, the source code can be for network functions on a dataplane. In this case, step 514 of the method includes verifying new source code for software and or logic instructions operating on the shadow data plane. According to certain non-limiting examples, step 514 can be performed using the verification mode 606 and the decision block 608, which are illustrated in FIG. 6 and are described below with reference to FIG. 6.

According to some examples, in step 516, the method includes promoting new source code for software and or logic instructions to primary dataplane infrastructure (e.g., by transitioning the data flow from the previous primary dataplane to the previous shadow dataplane, which becomes the new primary dataplane). According to certain non-limiting examples, step 516 can be performed using the promotion mode 610, which is illustrated in FIG. 6 and is described below with reference to FIG. 6.

According to certain non-limiting examples, the verification process that is disclosed herein using the shadow dataplane can replace previous methods of verification testing. Alternatively, the verification process that is disclosed herein can be combined with, rather than replace, previous methods of verification testing (e.g., step 510) that exist as a normal course of the Software Development Lifecycle (SDLC). For example, code commits can be continuously integrated and tested in a staging environment, prior to the use of the shadow-dataplane-based verification process in a production environment. Once staging-phase testing is complete, the code can be merged into the production branch and pushed into production. For example, the shadow-dataplane-based verification process can provide a unique non-disruptive way as the last stage of the continuous integration, continuous deployment (CI/CD) promotion pipeline.

Failures (e.g., defects, bugs, or vulnerabilities) detected in the production/deployment testing (i.e., during the Verification Mode) can indicate a field escape of a bug that was missed during the QA process (e.g., the testing in step 510). Thus, the production/deployment testing (i.e., during the Verification Mode) provides a way to prevent the bug from negatively impacting production by doing out-of-band verification within the actual production environment (e.g., the customer's own network), but in a manner that is not disruptive and/or is invisible to the customer (e.g., without the disruption of software rollbacks).

Failures (e.g., defects, bugs, or vulnerabilities) detected in the production/deployment testing can be treated as field escapes. Although verification-mode failures do not negatively impact production, they can, however, incur other costs associated with QA field escapes (e.g., delay in getting new code to production, need to reverse engineer the failure, need to augment QA testing in staging to ensure this type of escape does not reoccur). Thus, the Verification Mode failures can be treated as field escapes by automatically generating bug reports for the team to address in both the software-development phase and staging-test phase (e.g., step 508 and step 510).

FIG. 6 illustrates a non-limiting example of process 512. According to certain non-limiting examples, step 502 goes from start 602 to the normal mode 604.

In normal mode 604, packets are simply sent through the primary dataplane and processed as normal. The shadow dataplane is in standby, waiting for the deployment of new software and/or new policies (e.g., the new software can require verification while operating on the shadow dataplane before it can ultimately be deployed on the primary dataplane), which results in verification request 614 causing the system to transition from normal mode 604 to verification mode 606. Alternatively, scale-out request 626 can cause the system to transition from normal mode 604 to scale-out mode 612, which is used to increase the throughput of packets processed through the system.

In scale-out mode 612, the idle resources in the shadow dataplane can be put to use for load balancing. In the absence of a shadow dataplane, a mechanism for scale-out of the network edge device is to leverage resources along the application path. However, there may be cases where a device is overloaded and there is no way to shift load around in the immediate term. When this is the case, additional resources may become temporarily available by switching to scale-out mode 612 to take advantage of the shadow dataplane. Scale-out mode 612 is initiated by a scale-out request 626, and then terminated when there is no longer a need for additional resources, resulting in signal 624 indicating that the normal capacity threshold is maintained.

According to certain non-limiting examples, in scale-out mode 612, any verification testing currently being processed is canceled, and a pause is put on accepting verification testing. The system engages both dataplanes as Active/Active (i.e., the primary dataplane is in an active state and the shadow dataplane is in an active state, rather than standby). Both dataplanes implement a current version of the software/policy. The packet dispatcher load balances packets across the active dataplanes to use all available capacity. For example, in a pure x86 or Advanced RISC Machine (ARM) system, this can be implemented as another pipeline to process packets, spreading the workload across more cores. In a system with DPUs, e.g., this means taking advantage of the additional hardware capacity on the DPUs.

According to certain non-limiting examples, in verification mode 606, packets are mirrored through two versions of the software and/or policy, which are running concurrently. The primary dataplane can be agnostic to the fact that the system is in verification mode and simply functions as it normally would. The shadow dataplane implements the new software and/or policy, and the shadow dataplane drops packets at the end of the pipeline rather than transmitting them. That is, both the primary dataplane and the shadow dataplane receive the same packets, making it possible to perform a direct comparison between the performance of the current and new versions of the software/policy. Further, this comparison is performed using the customer's actual traffic, and this comparison is performed transparently, without any impact on the execution of the network.

As part of (or separate from) the verification mode 606, the decision block 608 includes checking verification results 616 to determine, after a specified testing interval, whether the new version passed or failed the verification test(s). If the verification fails, the fail signal 618 indicates that the shadow dataplane has not been authorized to take over as the primary dataplane. The system reverts to normal mode 604 without passing through promotion mode 610, and the system sends a message to the controller indicating the cause of the failure. A newer policy or software version is then developed and the verification mode 606 is reinitiated using the newer policy or software version. If verification testing passes, the system generates a signal of pass 620 and moves to promotion mode 610.

According to certain non-limiting examples, decision block 608 can determine whether the new version passes the verification test based on the accumulated confidence over a period of time. The steps of method 200 can be used to ensure that the testing has provided sufficient code coverage that essentially all relevant parts of the source code that are relevant to the production environment have been tested. For example, a confidence score can depend on the ratio of the number of tracepoints activated during testing compared to the total number of tracepoints that have been registered in a historical log for previous versions of the source code in the production environment.

Accordingly, the confidence score can increase as packets are processed through the primary dataplane and the shadow dataplane and the accumulated statistics and measurements/comparisons between the respective dataplanes fall within desired parameters. The code-coverage metric can be used to confirm that testing on a sufficient portion of the new source code has been performed. As testing continues over time the number of activated tracepoint will increase, approaching the number of tracepoints registered in the historical log. As testing continues without deviations outside of predefined limits, the confidence increases that the new version is behaving in an acceptable/desirable manner. When the confidence score exceeds a predefined value over a predefined testing period, then the new version is determined to have passed the verification test.

Testing can continue until the code-coverage metric satisfies one or more coverage criteria. If, after the code-coverage metric satisfies one or more coverage criteria, a large number of bugs have been found, the confidence score can fall below the predefined value indicating failure and corrective action is taken to modify the new version before subsequent verification testing. A failed verification test occurs when the confidence score is less than a failure threshold. A passed verification test occurs when the confidence score exceeds a pass threshold. The confidence score can depend, at least in part, on the code-coverage metric discussed above.

Once verification mode 606 is complete and the new version has passed the verification, promotion mode 610 is initiated to promote the shadow dataplane to the primary dataplane. Preferably, this promotion is performed gracefully to minimize disruption to the running system. Further, this promotion can be performed gradually, in case a rollback becomes required due to there being any issues that were missed during verification.

According to certain non-limiting examples, in promotion mode 610, the shadow dataplane becomes the “primary pending” dataplane and the packet dispatcher begins forwarding all new flows to the primary pending dataplane. Once these flows are observed to flow normally, existing flows are gracefully migrated from the primary dataplane to the primary pending dataplane until all flows are transiting through the primary pending dataplane. At this point, the primary dataplane moves to the shadow dataplane, and the primary pending dataplane to the primary dataplane. Then the signal for the primary and shadow role exchange 622 is triggered, sending the state machine representing process 512 back to normal mode 604.

Returning to verification mode 606, verification can be predicated on assessing the difference in behaviors of two versions of network software and/or network policies. In many cases, a comparison between the two versions is more involved than merely observing that the performance of the new version matches the performance of the current version. For example, the new version can be expected to perform differently than the current version. For example, the new version might be intended to improve performance in certain aspects relative to the current version. Thus, the comparison between the performances of the two versions can be informed regarding expected differences in performance due to improvements integrated into the new versions, and, in anticipation of these differences, the comparison can set out criteria for the verification testing that account for the expected differences in performance.

In one case that exemplifies a simple verification, the new version of the software is a minor revision to the current software that is limited to optimizing the pipeline to improve performance. In this case, verification can be straightforward because the expected result of the new version of the software is that the same number of packets are received and transmitted, the same policies are matched, the CPU and memory usage are the same or lower, the latency of packets transiting the dataplane is reduced and the effective throughput increased. Thus, basic heuristics can be used to determine whether the new version is an improvement relative to the current version, which would signify a successful verification.

In other cases, however, verification is not as simple as in the above example. In such cases, new versions of software and policy can be accompanied by metadata that can inform the system how to interpret the results of the comparison between performances of the current and new versions to establish predefined criteria for verification.

In these more complicated/non-trivial verification cases, verification criteria can be established for various aspects of the performance comparison. For example, to determine that the new version of the software will not disrupt the network, various different factors can be considered for the metrication of the performance when executing a firewall dataplane, including, e.g., CPU performance, memory usage, packet latency, and traffic volume. For example, the predefined verification criteria can include metrics related to changes in the CPU usage, including, e.g., the minimum CPU usage, the maximum CPU usage, and the average CPU usage. Further, the predefined verification criteria can include metrics related to o changes in memory usage, including, e.g., the minimum memory usage, the maximum memory usage, the average memory usage, and memory growth over the verification period. Additionally, the predefined verification criteria can include metrics related to changes in the packet latency, including, e.g., the average time it takes packets to traverse the dataplane.

In addition to the above performance metrics, the predefined verification criteria can include various traffic-volume metrics. These traffic-volume metrics can include, e.g., the total number of packets processed, the number of dropped packets, and the number of packets that are transmitted (i.e., transmitted from the ports to other network devices). In certain verification cases, it is anticipated that traffic volume should be identical at egress, between the primary and shadow dataplanes. For example, if N packets arrived and K packets were dropped due to policy, L packets should be transmitted at the end. For verification to be precise, the exact same number of packets (e.g., N packets) can be ensured on both dataplanes. The exact same number of packets can be ensured, e.g., by sending an inline control packet that signals the start and end of verification. This ensures that both dataplanes are operating on the same N.

Whereas traffic volume should be identical at egress for cases in which the policies or other aspects of the processing do not change the number of dropped packets, in other cases the number of dropped packets can change, but often the number of dropped packets will change in predictable ways, which can be communicated via the accompanying metadata to generate traffic-volume metrics that are indicative of the predicted changes. That is, some versions of software may alter the number of dropped packets (e.g., above K value) for valid reasons.

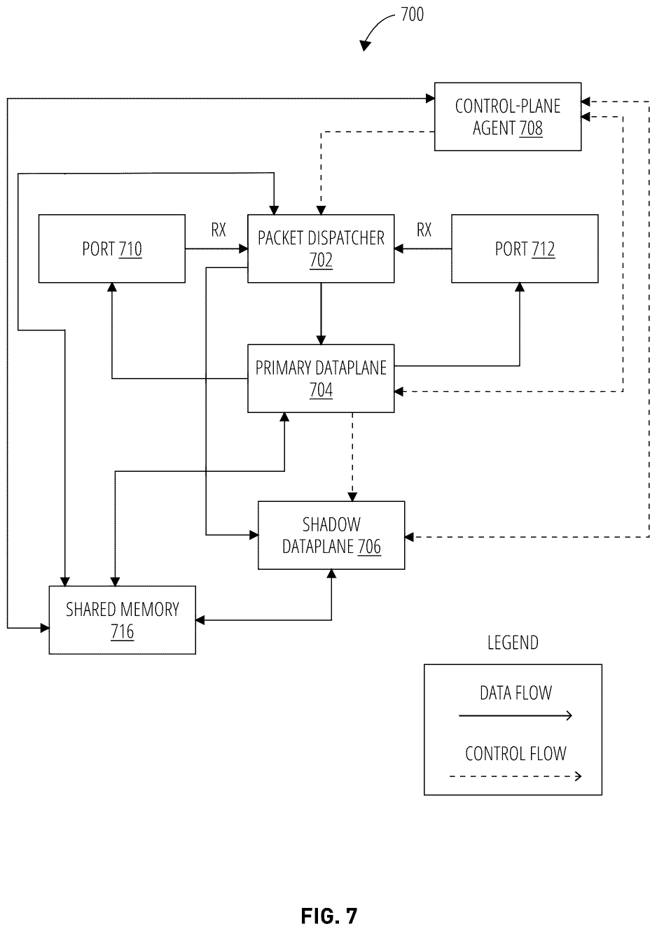

FIG. 7 illustrates a non-limiting example of a dual dataplane architecture 700 for a network appliance. In a physical or virtual machine that does not have access to DPUs, the systems and methods disclosed herein provide the ability to run concurrent dataplanes in parallel to support the dual dataplane model of CI/CD upgrades with inline validation.

As illustrated in FIG. 7, ingress packets are received through port 710 and port 712 to the packet dispatcher 702, and then the packet dispatcher 702 selects which of these data packets to direct to the primary dataplane 704 and the shadow dataplane 706. For example, in the verification mode 606 the packets can be mirrored such that identical replicas are sent to both dataplanes. In contrast, in the scale-out mode 612, different sets of data packets can be directed to each of the dataplanes. In FIG. 7 only the packets from the primary dataplane 704 are transmitted to port 710 and port 712, which is reflective of the normal mode 604 and the verification mode 606. In the scale-out mode 612, however, both dataplanes will process and transmit packets from the network component/device implemented using the dual dataplane architecture 700. Additionally, throughout the promotion mode 610, the “New Primary” dataplane (i.e., shadow dataplane 706) can gracefully transition from not sending packets to the ports to being the only of the two dataplanes that is sending packets to the ports. Control signal flow between the control-plane agent 708 and each of the packet dispatcher 702, the primary dataplane 704, and the shadow dataplane 706. Further, control signal can flow from the primary dataplane 704 to the shadow dataplane 706.

The dual dataplane architecture 700 includes a shared memory 716 that can be accessed by respective components of the dual dataplane architecture 700, including, e.g., being accessed by the packet dispatcher 702, primary dataplane 704, shadow dataplane 706, and control-plane agent 708. The shared memory 716 enables the dataplanes to operate as stateless as possible by storing state-type information in the shared memory 716, which is accessible by all components of the system. This can allow the packet dispatcher 702 to monitor the performance of both dataplanes. Further, these features can also allow flows to be migrated from one dataplane to the other since the state is isolated.

The dual dataplane architecture 700 uses several functions to realize the various modes. For example, the network devices can be deployed on high availability (HA), and, more particularly, two modes of high availability (HA) can be used: (i) active/standby HA between the dataplanes (e.g., when in the Normal Mode active/standby HA is used with the primary dataplane in active HA and the shadow dataplane in standby HA) and (ii) active/active HA between the dataplanes (e.g., when in the Scale-out Mode active/active HA is used with both the primary dataplane and the shadow dataplane in active HA).

For example, when the network device is a firewall, operating in active/standby HA entails that the first firewall processes all the traffic, and the second firewall, which is a clone of the first firewall, is waiting to take over. Continuing the non-limiting firewall example, operating in active/active HA entails both the first firewall and the second firewall are active (i.e., processing traffic). For example, half the traffic can be sent to the first firewall and the remaining half the traffic can be sent to the second firewall, thereby leveraging all of the compute on that system.

Another function enabled by the dual dataplane architecture 700 is mirroring the packets to the shadow dataplane by sending replicas of the packets through both dataplanes. Because replicas of the packets are used through both dataplanes, this function is used in the verification mode to allow an apples-to-apples type comparison for verification testing between the current version of the network-device software, which is operating on the shadow dataplane. Based on this comparison, the system can tell if the new network software (or new network policy) satisfies predefined verification criteria and passes the verification test to replace the old network software (or old network policy).

Another function enabled by the dual dataplane architecture 700 is gracefully transitioning flows from the “Old Primary” to “New Primary” dataplane (e.g., in the promotion mode).

These functions are enabled (in part) by: (i) keeping the dataplanes as stateless as possible and (ii) storing state-type information in a shared memory that is accessible by all components of the dual dataplane architecture 700. This allows the packet dispatcher 702 to monitor the performance of both dataplanes. This also allows flows to be migrated from one dataplane to the other because the state is isolated.

Additionally, the dataplanes can share additional components. For example, the dataplanes can share a common random number generator. Consider the case in which the dataplanes are used when performing men-in-the-middle interception of TLS sessions. In this case, a secret key is generated, and the key should be the same value for both dataplanes so that the traffic can be mirrored through both data planes. That is, the dataplanes need to generate the identical key, so that they can understand the resulting response in the TLS session. The keys are generated using a random number from a random number generator. Accordingly, by using the same random number from a common random generator, the dataplanes can generate the same unique key for TLS or similar processes.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-logic instructions that are stored or otherwise available from computer readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The computer logic instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Aspect 1. A method for dynamically determining/calculating an environment-specific code coverage, the method comprising: embedding tracepoints in a first version of source code, each of the tracepoints having a unique identifier; determining first information representing first set of the tracepoints that have been executed at least once within a first period; determining second information representing second set of the tracepoints that have been activated during a second period spanning a first test of the first version of the source code; and analyzing the first information and the second information to generate an analysis result representing a code coverage of the first test.

Aspect 2. The method of aspect 1, wherein: the tracepoints are embedded in the first version of the source code using a macro that generates the unique identifier of a tracepoint based on one or more compile-time parameters associated with the tracepoint, the determining of the first information includes registering the first set of the tracepoints when first executed, the first set of the tracepoints being registered by storing unique identifiers of the first set of the tracepoints in a persistent memory, and the first information includes a first count representing how many tracepoints are in the first set of the tracepoints, and the determining of the second information includes counting the second set of the tracepoints, which are activated during a runtime session of the first test, to provide a second count representing how many tracepoints are in the second set of the tracepoints.

Aspect 3. The method of aspect 2, The method of claim 1, wherein the one or more compile-time parameters associated with the tracepoint include at least one of a file name or a line number.

Aspect 4. The method of aspect 2, wherein the analysis result includes a ratio of the second count and the first count.

Aspect 5. The method of any of aspects 1-4, wherein the unique identifier is generated using at least one of a file name or a line number of the tracepoint.

Aspect 6. The method of any of aspects 1-5, wherein: the first period includes a testing period that includes a first time during which the first version of the source code is executed and includes a historical period during which a second version of the source code is executed, the second period includes the testing period that includes a second time during which the first version of the source code is executed, the first version of the source code is a next version of the source code, and the second version of the source code is a current version of the source code or a previous version of the source code, and a list of the unique identifiers of the tracepoints that is stored in a persistent memory is a historical log of tracepoints that have been active in a specific environment.

Aspect 7. The method of aspect 6, further comprising: replacing, in a production environment, a previous program based on the second version of the source code with an updated program based on the first version of the source code, when the analysis result satisfies one or more code-coverage criteria.

Aspect 8. The method of any of aspects 1-7, wherein the determining of the first information includes: generating a historical log of tracepoints that have been active in an environment as the first set of the tracepoints, and the historical log is generated by storing, upon a first execution of a tracepoint, the unique identifier of the tracepoint in a persistent storage medium.

Aspect 9. The method of any of aspects 1-8, wherein the determining of the first information includes: ensuring each of the tracepoints is registered at most once by defining a registers-tracepoint function that registers a tracepoint only upon a first time the tracepoint is executed, wherein the registers-tracepoint function is defined using a static flag and a mutual exclusion synchronization primitive that provides thread safety.

Aspect 10. The method of any of aspects 1-9, wherein determining the first information representing the first set of the tracepoints is dynamic such that the first set of the tracepoints dynamically grows to provide an environment-specific code coverage such that the first period begins at a start time but is open ended with respect an end time, wherein newly executed tracepoints continue to be added to the first set of the tracepoints.

Aspect 11. The method of aspect 8, wherein storing the unique identifier of the tracepoint in the persistent storage medium further includes asynchronously persisting tracepoint registration data that includes the unique identifier from an in-memory data structure to the persistent storage medium.

Aspect 12. The method of any of aspects 1-11, further comprising: generating executable code from source code, including a tracepoint generator searching the source code for a tracepoint macro and inserting the tracepoints at locations in the source code associated with the tracepoint macro; executing, during a runtime session corresponding to the first test, first executable code generated from the first version of the source code; counting a number of unique tracepoints activated during the runtime session to generate a first count, wherein the second information includes the first count and the analysis result depends on the first count; and determining, based on the first count, whether the code coverage of the first test is insufficient and additional testing is to be performed for the first version of the source code, wherein determining that the additional testing is to be performed for the first version of the source code is based on a comparison of the first count to a second count representing a number of tracepoints in the first set of the tracepoints to determine a code coverage metric of the first test relative to a historical coverage data, such that when the code coverage metric does not satisfy one or more code coverage criteria (e.g., does not exceed a predefined code coverage threshold) a determination is made to perform the additional testing.

Aspect 13. The method of aspect 12, further comprising: performing the additional testing by continuing the runtime session of the first test until the second count has increased enough that the code coverage metric satisfies the one or more code coverage criteria.

Aspect 14. The method of any of aspects 1-13, wherein the analysis result includes a comparison between unique identifiers of the first set of the tracepoints with the unique identifiers of respective tracepoints of the second set of the tracepoints (e.g., determining which of the first set of the tracepoints were not activated during a runtime session of the first test).

Aspect 15. The method of any of aspects 1-14, wherein the first test is performed in a production environment using actual user data in realtime.

Aspect 16. The method of any of aspects 1-15, further comprising embedding, in source code, the tracepoints, wherein the tracepoints respectively have unique identifiers, and the tracepoints are embedded using a macro that generates the unique identifiers based on compile-time parameters; registering, in a persistent memory upon first being executed, the unique identifier of an executed tracepoint to provide historical tracepoint data; performing the first test of the first version of the source code by executing an executable program based on the first version of the source code and maintaining a first count of activated tracepoints during a runtime session as the first set of the tracepoints, wherein the activated tracepoints are a set of the tracepoints that are activated at least once during the runtime session; analyzing the first count and a second count representing how many tracepoints are in the first set of the tracepoints to provide a ratio as a code-coverage metric as the analysis result.

Aspect 17. The method of any of aspects 1-16, further comprising: performing the first test of the first version of the source code by executing an executable program based on the first version of the source code.

Aspect 18. The method of any of aspects 1-17, wherein: the first test is performed on a shadow dataplane of a multi-dataplane architecture in which the shadow dataplane executes logic instructions based on the first version of the source code and a primary dataplane of the multi-dataplane architecture performs other logic instructions based on a second version of the source code, the first version of the source code is a next version of the source code, and the second version of the source code is an earlier version of the source code, which was written before the next version of the source code.

Aspect 19. A method for dynamically determining/calculating an environment-specific code coverage, the method comprising: embedding, in source code, tracepoints, wherein each of the tracepoints has a unique identifier, wherein the tracepoints are embedded using a macro that generates the unique identifiers based on compile-time parameters; performing a runtime session to test an updated version of a source code; building a historical log of executed tracepoints by storing, in a persistent storage medium, a unique identifier of an executed tracepoint when the executed tracepoint is first executed during a historical period that includes at least one run time session of one or more versions of the source code generated before the updated version of the source code; maintaining a running tally of a number of activated tracepoints that are activated at least once during the runtime session; and dynamically calculating a code coverage metric by dividing the number of activated tracepoints by a number of tracepoints in the historical log.

Aspect 19. A computing apparatus configured including: one or more processors; and a memory storing instructions that, when executed by the one or more processors, configure the computing system to perform the method of any of aspects 1 to 19.

Aspect 20. A non-transitory computer-readable storage medium, the computer-readable storage medium including instructions that when executed by a computer, cause the computer to perform the method of any of aspects 1 to 19.

What is claimed is:

1. A method for determining code coverage, the method comprising:
embedding tracepoints in a first version of source code, each of the tracepoints having a unique identifier;
determining first information representing first set of the tracepoints that have been executed at least once within a first period;
determining second information representing second set of the tracepoints that have been activated during a second period spanning a first test of the first version of the source code; and
analyzing the first information and the second information to generate an analysis result representing a code coverage of the first test.

2. The method of claim 1, wherein:
the tracepoints are embedded in the first version of the source code using a macro that generates the unique identifier of a tracepoint based on one or more compile-time parameters associated with the tracepoint,
the determining of the first information includes registering the first set of the tracepoints when first executed, the first set of the tracepoints being registered by storing unique identifiers of the first set of the tracepoints in a persistent memory, and the first information includes a first count representing how many tracepoints are in the first set of the tracepoints, and
the determining of the second information includes counting the second set of the tracepoints, which are activated during a runtime session of the first test, to provide a second count representing how many tracepoints are in the second set of the tracepoints.

3. The method of claim 2, The method of claim 1, wherein:
the one or more compile-time parameters associated with the tracepoint include at least one of a file name or a line number, and
the analysis result includes a ratio of the second count and the first count.

4. The method of claim 1, wherein:
the first period includes a testing period that includes a first time during which the first version of the source code is executed and includes a historical period during which a second version of the source code is executed,
the second period includes the testing period that includes a second time during which the first version of the source code is executed,
the first version of the source code is a next version of the source code,
the second version of the source code is a current version of the source code or a previous version of the source code, and
a list of the unique identifiers of the tracepoints that is stored in a persistent memory is a historical log of tracepoints that have been active in a specific environment.

5. The method of claim 4, further comprising:
replacing, in a production environment, a previous program based on the second version of the source code with an updated program based on the first version of the source code, when the analysis result satisfies one or more code-coverage criteria.

6. The method of claim 1, wherein the determining of the first information includes:
generating a historical log of tracepoints that have been active in an environment as the first set of the tracepoints, and
the historical log is generated by registering, upon a first execution of a tracepoint, the unique identifier of the tracepoint in a persistent storage medium.

7. The method of claim 1, wherein the determining of the first information includes:
ensuring each of the tracepoints is registered at most once by defining a registers—tracepoint function that registers a tracepoint only upon a first time the tracepoint is executed, wherein the registers-tracepoint function is defined using a static flag and a mutual exclusion synchronization primitive that provides thread safety.

8. The method of claim 1, wherein determining the first information representing the first set of the tracepoints is dynamic such that the first set of the tracepoints dynamically grows to provide an environment-specific code coverage such that the first period is open ended with respect an end time, wherein newly executed tracepoints continue to be added to the first set of the tracepoints.

9. The method of claim 6, wherein storing the unique identifier of the tracepoint in the persistent storage medium further includes asynchronously persisting tracepoint registration data that includes the unique identifier from an in-memory data structure to the persistent storage medium.

10. The method of claim 1, wherein:
the analysis result includes a comparison between unique identifiers of the first set of the tracepoints with the unique identifiers of respective tracepoints of the second set of the tracepoints to determine which of the first set of the tracepoints were not activated during a runtime session of the first test, and
the method further includes:
using the analysis result to generate synthetic test data directed to testing parts of the first version of the source code corresponding to tracepoints of the first set of the tracepoints that are to determined were not activated during the runtime session of the first test, and
during a continuation of the first test, processing the synthetic test data using the first version of the source code and increasing the second set of the tracepoints to include tracepoints that have been activated during the second period spanning the first test, including the continuation of the first test.

11. The method of claim 1, further comprising:
performing the first test of the first version of the source code by executing an executable program based on the first version of the source code.

12. The method of claim 1, wherein:
the first test is performed on a shadow dataplane of a multi-dataplane architecture in which the shadow dataplane executes logic instructions based on the first version of the source code and a primary dataplane of the multi-dataplane architecture performs other logic instructions based on a second version of the source code,
the first version of the source code is a next version of the source code, and
the second version of the source code is an earlier version of the source code, which was written before the next version of the source code.

13. A computing system comprising:
one or more processors; and
a memory storing instructions that, when executed by the one or more processors, configure the computing system to:
embed tracepoints in a first version of source code, each of the tracepoints having a unique identifier;
determine first information representing first set of the tracepoints that have been executed at least once within a first period;
determine second information representing second set of the tracepoints that have been activated during a second period spanning a first test of the first version of the source code; and
analyze the first information and the second information to generate an analysis result representing a code coverage of the first test.

14. The computing system of claim 13, wherein:
the tracepoints are embedded in the first version of the source code using a macro that generates the unique identifier of a tracepoint based on one or more compile-time parameters associated with the tracepoint,
the determining of the first information includes registering the first set of the tracepoints when first executed, the first set of the tracepoints being registered by storing unique identifiers of the first set of the tracepoints in a persistent memory, and the first information includes a first count representing how many tracepoints are in the first set of the tracepoints, and
the determining of the second information includes counting the second set of the tracepoints, which are activated during a runtime session of the first test, to provide a second count representing how many tracepoints are in the second set of the tracepoints.

15. The computing system of claim 14, wherein:
the one or more compile-time parameters associated with the tracepoint include at least one of a file name or a line number, and
the analysis result includes a ratio of the second count and the first count.

16. The computing system of claim 13, wherein:
the first period includes a testing period that includes a first time during which the first version of the source code is executed and includes a historical period during which a second version of the source code is executed,
the second period includes the testing period that includes a second time during which the first version of the source code is executed,
the first version of the source code is a next version of the source code,
the second version of the source code is a current version of the source code or a previous version of the source code, and
a list of the unique identifiers of the tracepoints that is stored in a persistent memory is a historical log of tracepoints that have been active in a specific environment.

17. The computing system of claim 16, wherein the instructions further configure the computing system to:
replace, in a production environment, a previous program based on the second version of the source code with an updated program based on the first version of the source code, when the analysis result satisfies one or more code-coverage criteria.

18. The computing system of claim 13, wherein, to determine the first information, the instructions further configure the computing system to:
generate a historical log of tracepoints that have been active in an environment as the first set of the tracepoints, wherein
the historical log is generated by registering, upon a first execution of a tracepoint, the unique identifier of the tracepoint in a persistent storage medium.

19. The computing system of claim 18, wherein registering the unique identifier of the tracepoint in the persistent storage medium further includes asynchronously persisting tracepoint registration data that includes the unique identifier from an in-memory data structure to the persistent storage medium.

20. A non-transitory computer-readable storage medium, the computer-readable storage medium including instructions that when executed by a computer, cause the computer to:
embed tracepoints in a first version of source code, each of the tracepoints having a unique identifier;
determine first information representing first set of the tracepoints that have been executed at least once within a first period;
determine second information representing second set of the tracepoints that have been activated during a second period spanning a first test of the first version of the source code; and
analyze the first information and the second information to generate an analysis result representing a code coverage of the first test.
